(19) United States
(12) Patent Application Publication
(10) Pub. No.: US 2010/0107543 A1
(43) Pub. Date: May 6, 2010

(54) METHOD AND APPARATUS FOR THE MANUFACTURE OF PRE-CAST BUILDING PANELS

(76) Inventor: Geoff WYETT, Dubai (AE)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/687,244

(22) Filed: Jan. 14, 2010

Related U.S. Application Data
(62) Division of application No. 11/571,134, filed on Dec. 21, 2006.

(30) Foreign Application Priority Data
Jun. 22, 2004 (AU) 20044903395
Oct. 14, 2004 (AU) 2004905968

(51) Int. Cl. E04C 2/30; B28B 7/32; B29C 39/26

(52) U.S. Cl. 52/576; 425/438; 264/314

(57) ABSTRACT

The invention relates to an apparatus and method for moulding a substantially hollow building panel (12) of the kind having spaced opposed outer panel walls (14) interconnected by a plurality of spaced formations 16 such that adjacent formations each define a void (18) therebetween. The apparatus including a mould (20) having means to define an outer surface of least one of the outer panel walls and a plurality of spaced apart inflatable void forming plug members (26) connectable with an inflation means, disposed within the mould. The apparatus further including a means to introduce a settable wet mix into the mould.

### FIELD OF THE INVENTION

The present invention relates to building panels and in particular to generally hollow building panels.

The invention has been developed primarily as an apparatus and method for moulding a building panel and will be described hereafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of common general knowledge in the field.

It is known in the building industry to use precast wall panels in the erection of buildings and other structures particularly for residential or industrial applications. These panels are normally rectangular in configuration having two spaced apart opposing walls interconnected by a plurality of formations or webs. A void is left between adjacent formations to form a generally hollow building panel. In this way, the building panels are lighter and therefore easier and cheaper to transport and erect. Materials used in the construction of these building panels typically include concrete, plaster or fibreglass reinforced plaster. In addition, concrete may be poured into the voids once the building panels are erected so as to strengthen the final structure.

A conventional method for making building panels of this type is described in Australian Patent No 673,446 in the name of Geoffrey Grantham. Most generally this method first requires the setting up of a suitable tray-like horizontal mould. A quantity of settable wet mix is then introduced into the mould to form a first layer of predetermined thickness. A number of void forming plug members are then placed onto the first layer extending between opposite sides of the mould. Once the moulding is complete, the spaces between the plug members will define formations or webs in the completed panel.

A further quantity of settable wet mix is then added into the mould to sufficiently fill the spaces between the plug members and form a second layer. The settable wet mix in then allowed to reach a first set condition and the void forming plug members are removed. When the settable wet mix has completely set, the building panel is thus completed.

The settable wet mix usually incorporates some form of reinforcing material such as chopped fibreglass rovings or the like. A layer of reinforcing material is also added to the mould. Usually, this material is applied in a method similar to the manual laying of fibreglass mat.

It will be appreciated that this mould does not normally include any forming member that defines the outer face of the second wall of the panel. That is, the top most face of the panel is free formed and not moulded.

One problem with moulding building panels using this method is that a large force is required to extract the void forming members. This can result in the moulded building panel being damaged during the plug member extraction.

Another known problem encountered is the upward force applied to the void forming plug members during setting due to the hydrostatic pressure effect of a large body sitting in a pool of fluid. Since the void forming plug members are typically long slender members, bending of the unsupported regions can occur. This bending can lead to inconsistent thicknesses in the walls of the moulded building panels.

WO2004/001160 (ZWAANS) suggests a solution to the problem of excessive extraction force by disclosing a collapsible void forming plug member. Described is a void forming plug member including a plurality of movable outer shell portions surrounding an axially movable elongate core. Longitudinal movement of the core defines the expanded and contracted states of the void forming plug member. In this way, the collapsible void forming member can reduce its cross-sectional area after the wet mix has set, thereby substantially reducing the extraction force required.

Whilst this arrangement is an improvement over AU 673,446, it has been found that the complexity of the mechanism required can be problematic and may lead to costly maintenance regimes. In addition, WO2004/001160 ignores the second problem of the bending of the plug members and the resulting uneven wall thicknesses.

It is an object of the present invention to overcome or ameliorate at least one of the disadvantages of the prior art, or to provide a useful alternative.

### SUMMARY OF THE INVENTION

In this specification the terms “inflate” or “inflation” may be defined as to swell or distend with air, gas or any fluid.

According to a first aspect of the present invention there is provided an inflatable void forming plug member for use in moulding a substantially hollow building panel of the kind having spaced opposed outer panel walls interconnected by a plurality of spaced formations such that adjacent formations each define a void therebetween, the plug member including:

at least one inflatable bladder connectable to an inflation means; and

a supporting structure for the bladder,

the plug member being configured such that its outer surface defines the void shape when the bladders are in an inflated state.

According to one preferred embodiment of the first aspect, the bladder includes a flexible yet substantially inextensible material having good shape memory properties and desirably a single wall structure.

According to another preferred embodiment of the first aspect, the bladder includes a flexible but substantially inextensible single wall sleeve sealingly connected about a rigid or semi-rigid core of another material.

According to yet another preferred embodiment of the first aspect, the bladder includes a resilient single wall sleeve sealingly connected about a core.

According to a further preferred embodiment of the first aspect, the bladder is formed from a flexible but substantially inextensible sleeve sealingly connected about a rigid or semi-rigid core of another material. The sleeve preferably has a dual wall structure such that an inflatable cavity is defined between the walls.

Preferably, the bladder defines a substantially constant cross-sectional shape along its longitudinal axis when inflated.

According to a further preferred embodiment of the first aspect, the plug member includes:

an assembly of two or more inflatable bladders peripherally disposed about a rigid frame; and

a deformable semi-rigid sleeve substantially surrounding the assembly, the semi-rigid sleeve defining the outer surface such that inflation of the bladders causes at least a portion of the sleeve to expand to thereby define the void shape.

According to a second aspect of the present invention there is provided an apparatus for use in moulding a substantially hollow building panel of the kind having spaced opposed outer panel walls interconnected by a plurality of spaced formations such that adjacent formations each define a void therebetween, the apparatus including:

a mould having means to define an outer surface of least one of the outer panel walls;

a plurality of spaced apart inflatable void forming plug members according to the first aspect disposed within the mould;

an inflation means connectable with the plug members; and

a means to introduce a settable wet mix into the mould.

In a preferred form, the mould has a generally vertical orientation and the settable mix is preferably injected into a lower portion of the mould.

In this preferred vertical form the mould preferably includes at least two forming members defining the outer panel walls. Additionally, it is preferred that the mould includes two movable forming members or alternatively at least one stationary and one movable forming member defining the outer panel walls.

It is preferred that the void forming plug members are movable into and out of the mould. This is preferably achieved by traversing the plug members along their longitudinal axis.

Preferably, the apparatus further includes a support frame adapted to lift the plurality of void forming plug members from, and insert into, the mould. The support frame preferably includes a structure to support the bladder of each void forming plug member. A fluid manifold preferably provides an inflating fluid to the bladder of each of the plug members.

According to a third aspect of the present invention there is provided a method for moulding a substantially hollow building panel of the kind having spaced opposed outer panel walls interconnected by a plurality of spaced formations such that adjacent formations each define a void therebetween using the apparatus according to the second aspect, the method including the steps of:
(i) introducing the settable wet mix into the mould having the inflatable void forming plug members disposed therein;
(ii) inflating the plurality of inflatable void forming plug members;
(iii) deflating the plurality inflatable void forming plug members when the settable wet mix reaches a first set condition; and
(iv) removal of the thus moulded building panel from the mould.

It is preferred that the plurality of inflatable void forming plug members are removed from the mould before the moulded building panel is removed in step (iv). It is also preferred that the movable forming member, when included, is removed from the mould before the moulded building panel is removed in step (iv).

Preferably, a reinforcing structure is added to the mould before the settable wet mix reaches the first set condition. It is more preferred that the reinforcing structure is added to the mould before the settable wet mix is introduced in step (i).

In one form the reinforcing structure is a mesh basket made of a solid material with relatively strong tensile properties. Preferably, the reinforcing structure is substantially formed from fibreglass. Alternatively, the reinforcing structure is formed from polypropylene or nylon or other suitable material.

In a preferred form, the settable wet mix includes plaster and strands of fibreglass. The settable wet mix may include a cement based mixture.

Preferably, the settable wet mix includes a mould-releasing agent to ensure that the moulded building panel can be easily removed from the mould and/or a mould releasing agent is applied to the mould.

Preferably, the plurality of inflatable void forming plug members are inflated by introducing an inflation gas into the bladders. In a preferred faun this gas is air. Alternatively, the plurality of inflatable void forming plug members are preferably inflated by introducing an inflation liquid into the bladders.

According to a fourth aspect of the present invention there is provided a building panel moulded according to the method of the third aspect.

In a preferred form of the building panel, the voids have a substantially constant cross-section about their longitudinal axis. It is also preferred that the voids extend uninterruptedly between two opposite ends of the panel.

Additionally, the voids are preferably equi-spaced along the length or the width of the panel.

### BRIEF DESCRIPTION OF THE DRAWINGS

A preferred embodiment of the invention will now be described, by way of example only, with reference to the accompanying drawings in which:

FIG. 1 is a sectional side view of a moulding apparatus according to one aspect of the present invention;

FIG. 2 is a sectional view of a building panel made using the apparatus of FIG. 1;

FIGS. 3a-3c are sectional views of three alternate embodiments of an inflatable void forming member according to another aspect of the invention;

FIG. 4 is a part elevation view of apparatus of FIG. 1;

FIG. 5 is an enlarged view of area B of FIG. 4; and

FIG. 6 is a sectional perspective view of a further embodiment of the inflatable void forming member.

### DESCRIPTION OF THE PREFERRED EMBODIMENT

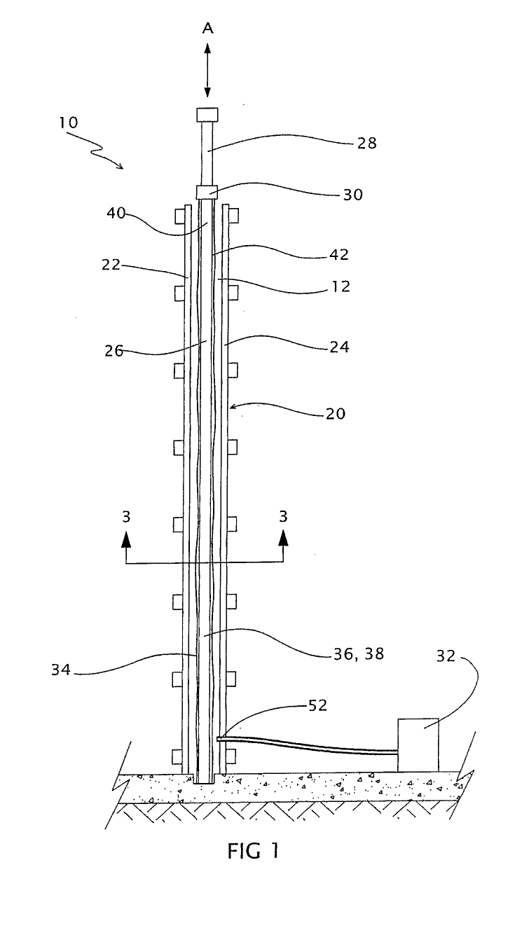

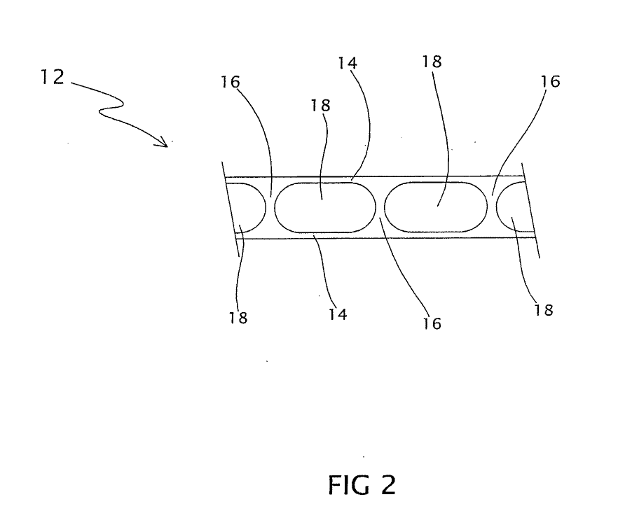

Referring to the drawings and more particularly to FIGS. 1 and 2, the moulding apparatus 10 is used to mould a substantially hollow building panel 12 of the kind having spaced opposed outer panel walls 14 interconnected by a plurality of spaced formations 16 such that adjacent formations each define a void 18 therebetween. The apparatus includes a mould 20 having two primary wall forming members 22, 24, which define the external faces of walls 14 of the building panel to be moulded.

A plurality of spaced apart inflatable void fowling plug members 26 are selectively disposed within the mould. The apparatus further includes a lifting frame 28, an inflation manifold 30 and a pump-mixer unit 32.

In this preferred embodiment, each inflatable void forming plug member 26 includes an inflatable bladder 34 surrounding a core 36. The core is in the form of a rectangular hollow section 38, which is supported by the frame 28. The bladder is formed from a flexible yet substantially inextensible single wall material, which is sealingly connected about the rectangular hollow section. The bladder is fluidly connected to the inflation manifold 30 contained within the frame such that when the bladder is inflated, its outer surface 32 defines the void shape of the substantially hollow building panel 12.

Inflation air travels from the manifold 30 to the internal portion 40 of the rectangular hollow section 38, via a fluid connection 54 and is then delivered to inflate the bladder 34 via small apertures 42 in the walls of the hollow section. Deflation of the bladder may be achieved by applying a negative pressure to the manifold 30 or alternatively, by simply opening the manifold to the atmosphere.

The mould further includes a stationary primary wall-fowling member 22 and a movable primary wall-forming member 24. In this preferred embodiment, these forming members define the outer faces of the walls 14 of the building panel 12. The sides and ends of the building panel 12 will be formed using other (not shown) forming members that may be movable or stationary. It is proposed that in a manufacturing environment, control of the movable forming member may be achieved by a robotic actuation system.

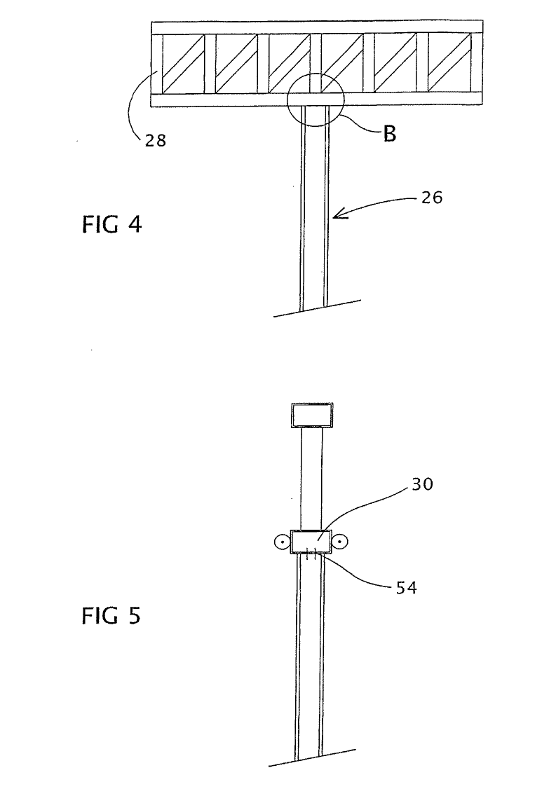

Lifting frame 28 provides a means for the plug members 26 to be extracted from the mould 20 by lifting them along direction A. FIG. 4 shows an alternate view of the lifting frame carrying a single plug member 26. It is also proposed that control of the lifting frame, in a manufacturing environment, is by way of a robotic actuation system.

The process of forming the building panel 12 using the moulding apparatus 10 will now be described with reference to FIGS. 1 to 5.

The mould 20 is first assembled by moving the forming member 24 into the correct location with respect to the stationary forming member 22. In addition, the void forming plug members 26 are positioned between forming members 22, 24. The number of plug members and their location should correspond to the desired number and configuration of void areas required in the moulded building panel. At this initial stage of the moulding process the plug members should be in a deflated state.

Depending on the desired mechanical properties of the building panel required, a strengthening mesh basket (not shown) made of a solid material can be placed over each of the void forming plug members. Ideally, the mesh basket is made from a material with favourable tensile and wet mix bonding properties.

A settable wet mix, containing plaster and strands of strengthening material such as fibreglass, is then pumped into a lower portion of the mould, the amount of which being dependent of the required height of the panel within the mould. The void forming plug members can now be inflated or may have been pre-inflated prior to introduction of the wet mix.

After a period of time, the settable wet mix will reach a first settable condition and the void forming plug members can then be deflated. The lifting frame then extracts the void forming plug members by lifting them in a direction substantially parallel to the longitudinal axis of the plug members (direction A).

Once the settable wet mix reaches a second set condition the movable forming member 24 is retracted such that the moulded building panel 12 may be removed. The building panel is then relocated to another area such that it may complete its hardening process. To assist in building panel removal, a mould releasing agent is either included in the settable wet mix or applied to the moulding surfaces of the forming members before the settable wet mix is introduced.

The thus moulded building panel 12 is generally hollow with two spaced apart, generally planar and rectangular opposed walls 14 of constant thickness. The walls are interconnected by a plurality of equi-spaced formations 16 or webs such that a void 18 is defined between adjacent webs. The voids are of constant cross-section and extend uninterruptedly from one end of the panel to the other.

Although the invention has been described above with reference to one preferred form, it will be appreciated by those skilled in the art that the invention may be embodied in many other forms. Further alternatives and variations are discussed below.

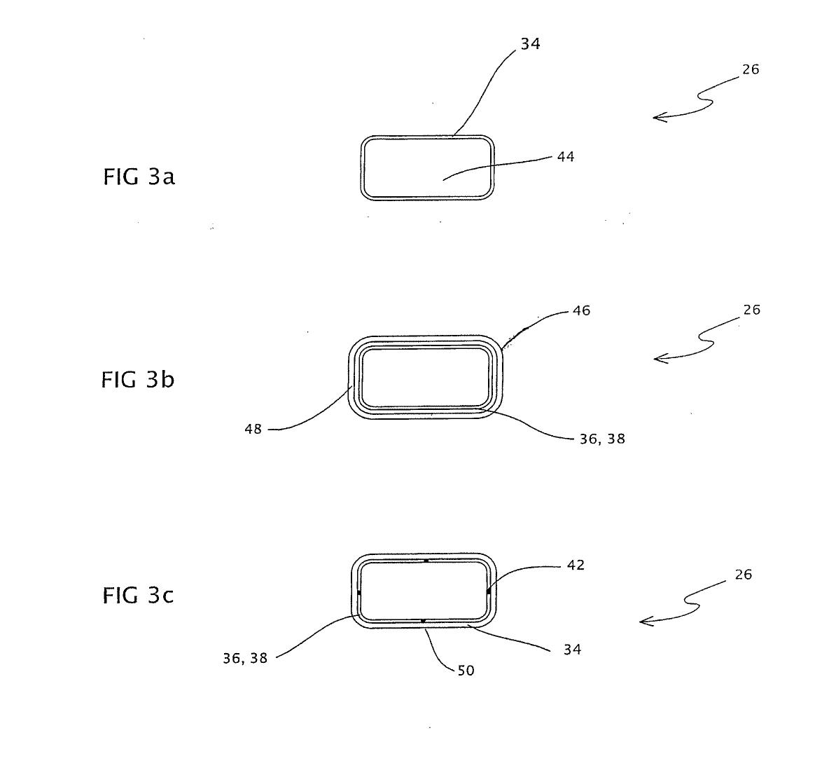

FIGS. 3a-3c are cross-sectional views taken through line 3-3 of FIG. 1 showing three alternate embodiments of the inflatable void forming plug member 26.

In the embodiment depicted in FIG. 3a, the inflatable void forming plug member 26 includes a bladder 34 formed from a flexible yet substantially inextensible material having good shape memory properties. The bladder is sealingly connected to a structure at either of its ends such that inflation air may be supplied to its centre 44 to inflate the bladder. It is proposed that the bladder 34 is self-supporting and only requires a structure, such as a portion of the lifting frame 28, to retain it in position.

An alternate embodiment of the plug member is depicted in FIG. 3b. The inflatable void forming member 26 includes a bladder formed from a flexible but substantially inextensible sleeve 46 sealingly connected about a core in the form of a rectangular hollow section 38. The sleeve 46 has a dual wall structure such that an inflatable cavity 48 is defined between the walls. The cavity is adapted to receive inflation air via a fluid connection with the manifold 30 such that, when inflated the inner wall will contact the hollow section 38 and the outer wall will define the void shape.

The embodiment shown in FIG. 3c is similar to the inflatable void member depicted in the FIG. 1 in that, the bladder 34 is formed from a flexible but substantially inextensible single wall sleeve 50 sealingly connected about a core 36. In this embodiment the core is again a rectangular hollow section 38. Inflation air is provided to the bladder from the central passage of the rectangular hollow section to the bladder via a plurality of apertures 42. Alternatively, in another not shown similar embodiment, a single wall resilient or elastic sleeve is used such that the sleeve is biased to the shape of the hollow section when not inflated.

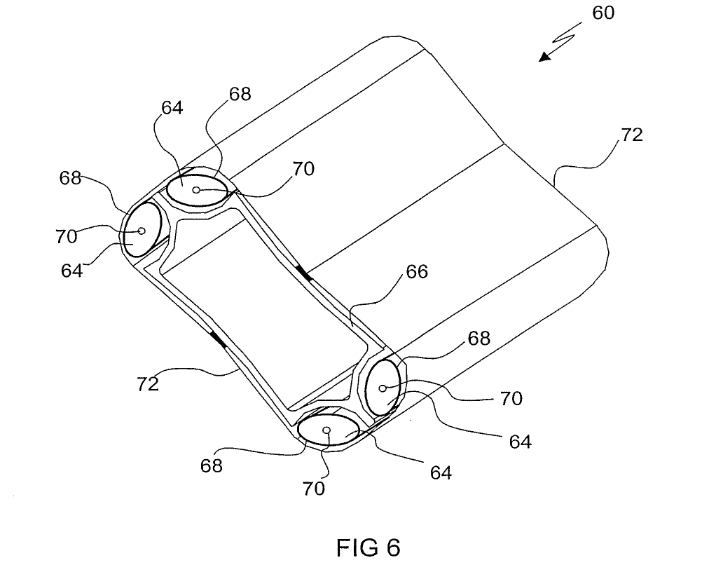

An alternate embodiment inflatable void forming member 60 is illustrated in FIG. 6. This embodiment differs from previous embodiments in that it includes an assembly 62 of four separate bladders 64 peripherally disposed about a rigid frame 66. Each bladder is formed from a resilient sleeve 68 disposed about a supporting member 70. A deformable semi-rigid sleeve 72 substantially surrounds the assembly such that inflation of the bladders causes at least a portion of the sleeve to expand and thereby define the desired void shape. It will be appreciated that in the embodiment any one of the bladder configurations mentioned above may be used.

It should be understood that although it has been disclosed that the mould 20 includes one primary stationary wall forming member 22 and one primary movable wall member 24, in other embodiments (not shown) both of the primary wall forming members may be movable. Also, the moulded building panel may be removed whilst the void forming plug members are stationary. For example, the void forming plug members 26 may be fixed to the ground and the moulded building panel removed from around the plug members.

The strengthening mesh basket may be constructed from nylon or polypropylene or fibreglass or a combination of these materials or any other solid material with desirable strength and wet mix bonding properties. Similarly, the settable wet mix may include cement, plaster, gypsum, fibreglass or a combination of these materials.

It should be further understood that although air has been used as the inflation medium, nitrogen or any fluid may be used without departing from the scope of the invention.

It will be appreciated that the apparatus and method of the present invention provides a solution to the problem of excessive extraction force of the plug members by disclosing a reliable collapsible void forming plug member that has a simple and inexpensive construction.

It will also be appreciated that preferred forms of the present invention provide a solution to the problem of bending of the void member due to hydrostatic pressure. That is, since the preferred form of the present invention discloses a vertically orientated mould, the force due to hydrostatic pressure will be even about the longitudinal axis of each plug member, thereby substantially eliminating any bending effect.

In addition, the present invention advantageously allows various heights of building panel to be moulded in one mould. As a result, custom sizes of panel may be produced with reduced waste.

The present invention also advantageously provides a method and apparatus to mould a building panel that has both external wall faces that are substantially finish fanned, which makes the final moulded building panel more aesthetically pleasing than building panels made using methods taught in the prior art, that have only one formed surface.

Furthermore, the apparatus disclosed is ideally suited to automation, wherein prior art methods typically require manual intervention.

Although the invention has been described with reference to specific examples, it will be appreciated by those skilled in the art that the invention may be embodied in many other forms.

1-12. (canceled)

13. An apparatus for use in molding a substantially hollow building panel having spaced opposed outer panel walls interconnected by a plurality of spaced formations such that adjacent formations each define a void therebetween, said apparatus including:
a vertically oriented mold having means to define an outer surface surfaces of said outer panel walls;
a plurality of spaced apart inflatable void forming plug members comprising at least one inflatable bladder disposed about a rigid frame, disposed within said mold;
an inflation fluid connectable with said plug members; and
a pump to introduce a settable wet mix into a lower portion of said mold.

14-15. (canceled)

16. An apparatus according to claim 13, wherein said mold includes at least two forming members defining said outer panel walls.

17. An apparatus according to claim 13, wherein said mold includes at least two movable forming members.

18. An apparatus according to claim 13, wherein said mold includes at least one stationary and at least one movable forming member defining said outer panel walls.

19. An apparatus according to claim 13, wherein said void forming plug members are moveable into and out of said mold.

20. An apparatus according to claim 19, wherein said void forming plug members are movable by traversing along their longitudinal axis.

21. An apparatus according to claim 13 including a support frame adapted to lift said plurality of void forming plug members from and into said mold.

22. An apparatus according to claim 13, further comprising a fluid manifold for conducting said inflating fluid to each of said plug members.

23. (canceled)

24. A method for molding a substantially hollow building panel having spaced opposed outer panel walls interconnected by a plurality of spaced formations such that adjacent formations each define a void therebetween, said method including the steps of:
(i) inflating a plurality of inflatable void forming plug members comprising at least one inflatable bladder disposed about a rigid frame disposed within a vertically mold;
(ii) introducing a settable wet mix into a lower portion of said mold;
(iii) deflating said plurality of inflatable void forming plug members when said settable wet mix reaches a first set condition; and
(iv) removing a molded building panel from said mold.

25. A method according to claim 24, wherein said plurality of inflatable void forming plug members are removed from said mold before said molded building panel is removed in step (iv).

26. (canceled)

27. A method according to claim 24, wherein a reinforcing structure is added to said mold before said settable wet mix reaches said first set condition.

28. A method according to claim 27, wherein said reinforcing structure is added to said mold before said settable wet mix is introduced in step (ii).

29. (canceled)

30. A method according to claim 27, wherein said reinforcing structure is substantially formed from fibreglass.

31. A method according to claim 27, wherein said reinforcing structure is substantially formed from polypropylene or nylon or other suitable material.

32. A method according to claim 24, wherein said settable wet mix includes plaster and strands of fibreglass.

33. A method according to claim 24, wherein said settable wet mix includes a cement based mixture.

34. A method according to claim 24, wherein said settable wet mix includes a mold-releasing agent.

35. A method according to claim 24, wherein a mold-releasing agent is applied to said mold.

36. A method according to claim 24, wherein said plurality of inflatable void forming plug members are inflated by introducing an inflation gas into said bladders.

37. A method according to claim 36, wherein said gas is air.

38. A method according to claim 24, wherein said plurality of inflatable void forming plug members are inflated by introducing an inflation liquid into said bladders.

39. (canceled)

40. A building panel molded according to the method of claim 24.

41. A building panel according to claim 40, wherein said voids have a substantially constant cross-section about their longitudinal axis.

42. A building panel according to claim 40, wherein said voids extend uninterruptedly between two opposite ends of said panel.

43. A building panel according to claim 40, wherein said voids are equi-spaced along the length or the width of said panel.

44. (canceled)

45. An apparatus according to claim 13, wherein said plug members comprise two or more inflatable bladders peripherally disposed about a rigid frame.

46. An apparatus according to claim 45, further comprising a deformable semi-rigid sleeve substantially surrounding said bladders.

47. A method according to claim 24, wherein said plug members comprise two or more inflatable bladders peripherally disposed about a rigid frame.

48. A method according to claim 47, further comprising a deformable semi-rigid sleeve substantially surrounding said bladders.
